(19) United States
(12) Patent Application Publication
(10) Pub. No.: US 2016/0170333 A1
(43) Pub. Date: Jun. 16, 2016

(54) ELECTROPHOTOGRAPHIC MEMBER AND ELECTROPHOTOGRAPHIC IMAGE FORMING APPARATUS

(71) Applicant: CANON KABUSHIKI KAISHA, Tokyo (JP)

(72) Inventor: Yasutomo Tsuji, Tokyo (JP)

(21) Appl. No.: 14/962,873

(22) Filed: Dec. 8, 2015

(30) Foreign Application Priority Data
Dec. 10, 2014 (JP) 2014-250402
May 27, 2015 (JP) 2015-107875

(51) Int. Cl. B32B 9/04; G03G 15/01

(52) U.S. Cl. CPC G03G 15/162

(57) ABSTRACT

An electrophotographic member includes a substrate and a surface layer, wherein the surface layer contains a binder resin having an acrylic skeleton and a modified silicone compound having a polyether group and a hydroxyl group. The surface of the electrophotographic member has a surface hardness measured by a nano-indentation method of 0.30 GPa or more and 0.50 GPa or less. The surface has contact angles with n-hexadecane of γ1 and γ2, with γ2 being a contact angle of the surface that has been subjected to an accelerated discharge test and left for 24 hours, and γ1 being a contact angle of the surface without the accelerated discharge test, where γ1 is 30.0° or more and 40.0° or less. A percent change in the contact angle defined by the following calculation formula (1) is 10% or less

percent change(%)=(|γ1−γ2|/γ1)×100 Calculation formula (1).

### BACKGROUND OF THE INVENTION

1. Field of the Invention

The present invention relates to an electrophotographic member used in electrophotographic image forming apparatuses such as copiers and printers, and an electrophotographic image forming apparatus.

2. Description of the Related Art

In electrophotographic image forming apparatuses, an electrophotographic photosensitive member made of an inorganic or organic material is charged, and the charged electrophotographic photosensitive member is exposed to light to form electrostatic latent images. Subsequently, the electrostatic latent images are developed with a toner subjected to triboelectric charging, and toner images are transferred and fixed onto a recording medium such as paper. Thus, desired images are formed on the recording medium.

Some electrophotographic image forming apparatuses employ an intermediate transfer system in which four-color toners (yellow, magenta, cyan, and black) are sequentially overlaid on an electrophotographic member such as an intermediate transfer body and then transferred onto a recording medium all together.

In order to achieve higher image quality in electrophotographic image forming apparatuses that employ an intermediate transfer system, it is important to improve the toner releasability on the surface of the intermediate transfer body and thus to improve the transfer efficiency of toner images onto a recording medium. Therefore, a surface layer containing a component for improving the releasability, such as a silicone component or a fluorine component, is formed on the intermediate transfer body.

The durability of electrophotographic members is desirably improved to decrease the replacement frequency of such members. In particular, it is important to increase the hardness of the surface of an intermediate transfer body in order to suppress abrasion and formation of scratches on the surface caused by a member (e.g., a cleaning blade, printing paper, and an external additive of toner) that contacts and slides with the intermediate transfer body.

Japanese Patent Laid-Open No. 2014-2423 discloses a conductive endless belt as an intermediate transfer body that achieves good transfer efficiency of toner and has good wear resistance. The conductive endless belt includes a hard coat layer having a pencil hardness of 4H or more and a contact angle with n-dodecane of 20° or more.

### SUMMARY OF THE INVENTION

Aspects of the present invention are directed to providing an electrophotographic member which has good wear resistance and in which good toner releasability is maintained for a long time.

Aspects of the present invention are also directed to providing an electrophotographic image forming apparatus with which high-quality electrophotographic images are stably formed.

According to an aspect of the present invention, an electrophotographic member includes a substrate and a surface layer, wherein the surface layer contains a binder resin having an acrylic skeleton and a modified silicone compound having a polyether group and a hydroxyl group in a molecule. A surface of the surface layer constitutes a surface of the electrophotographic member, and the surface of the electrophotographic member has a surface hardness measured by a nano-indentation method of 0.30 GPa or more and 0.50 GPa or less. The surface of the electrophotographic member has contact angles with n-hexadecane of γ1 and γ2, γ2 being a contact angle of the surface of the electrophotographic member that has been subjected to an accelerated discharge test and left for 24 hours after the accelerated discharge test, and γ1 being a contact angle of the surface of the electrophotographic member that is not subjected to the accelerated discharge test, where γ1 is 30.0° or more and 40.0° or less. A percent change in the contact angle defined by the following calculation formula (1) is 10% or less:

percent change(%)=(|γ1−γ2|/γ1)×100. Calculation formula (1)

According to another aspect of the present invention, an electrophotographic image forming apparatus includes an electrophotographic member including a substrate and a surface layer. The surface layer contains a binder resin having an acrylic skeleton and a modified silicone compound having a polyether group and a hydroxyl group in a molecule. A surface of the surface layer constitutes a surface of the electrophotographic member, and the surface of the electrophotographic member has a surface hardness measured by a nano-indentation method of 0.30 GPa or more and 0.50 GPa or less. The surface of the electrophotographic member has contact angles with n-hexadecane of γ1 and γ2, with γ2 being a contact angle of the surface of the electrophotographic member that has been subjected to an accelerated discharge test and left for 24 hours after the accelerated discharge test, and γ1 being a contact angle of the surface of the electrophotographic member that is not subjected to the accelerated discharge test, where γ1 is 30.0° or more and 40.0° or less. A percent change in the contact angle defined by the following calculation formula (1) is 10% or less:

percent change(%)=(|γ1−γ2|/γ1)×100. Calculation formula (1)

Further features of the present invention will become apparent from the following description of exemplary embodiments with reference to the attached drawings.

### BRIEF DESCRIPTION OF THE DRAWINGS

FIG. 1 illustrates an electrophotographic image forming apparatus according to an embodiment of the present invention.

FIG. 2 is a schematic sectional view illustrating an electrophotographic member according to an embodiment of the present invention.

FIG. 3 illustrates an accelerated discharge testing machine used in an embodiment of the present invention.

FIG. 4 schematically illustrates a surface layer according to an embodiment of the present invention.

### DESCRIPTION OF THE EMBODIMENTS

In recent years, high-speed printing required for electrophotographic image forming apparatuses and further improvement in toner transfer efficiency tend to increase the voltage (hereafter also referred to as a “secondary transfer voltage”) applied when a toner image on an intermediate transfer body is transferred onto a recording medium (hereafter also referred to as “secondary transfer”).

The present inventors have found that when the secondary transfer voltage is increased, a discharge phenomenon occurs between the surface of the intermediate transfer body and an image carrying member, which sometimes degrades the toner releasability on the surface of the intermediate transfer body. In other words, they have found that a releasing component such as a silicone component or a fluorine component contained in the surface layer of the intermediate transfer body is gradually decomposed by the discharging, and thus the toner releasability on the surface of the intermediate transfer body degrades. Hereafter, such degradation of surface characteristics of the intermediate transfer body (electrophotographic member) by discharging is referred to as “discharge degradation”. As a result of studies conducted by the present inventors on the conductive endless belt disclosed in Japanese Patent Laid-Open No. 2014-2423, it has been found that although formation of scratches and abrasion on the surface of the conductive endless belt are suppressed, the toner releasability on the surface of the conductive endless belt degrades due to a discharge phenomenon that occurs in an electrophotographic process. Once the toner releasability on the surface of the conductive endless belt degrades, the toner releasability does not recover.

Thus, the present inventors have recognized that electrophotographic members which have good wear resistance and in which good toner releasability can be maintained for a long time need to be developed.

Herein, the present inventors have known that the degradation of toner releasability is suppressed in electrophotographic members including a surface layer which contains a binder resin having an acrylic skeleton and a modified silicone compound having a polyether group and a hydroxyl group in a molecule and whose surface has a contact angle with n-hexadecane of 30.0° or more. This may be because even if a modified silicone compound present on the surface of the surface layer is decomposed by discharging and thus eliminated, a modified silicone compound retained inside the surface layer is supplied to the surface and thus the toner releasability recovers.

However, the addition of such a modified silicone compound to the surface layer tends to soften the surface layer. On the other hand, if the crosslinking density of a binder resin is increased to increase the surface hardness of the surface layer, the resulting dense crosslinked structure suppresses the movement of the modified silicone compound from the inside of the surface layer to the surface of the surface layer, and thus the toner releasability does not easily recover.

Accordingly, the present inventors have conducted studies in order to develop an electrophotographic member that achieves recovery of toner releasability and high surface hardness.

As a result, the present inventors have found that the above-described problems can be overcome by using an electrophotographic member including a substrate and a surface layer, wherein the surface layer includes a binder resin having an acrylic skeleton and a modified silicone compound having a polyether group and a hydroxyl group in a molecule; a surface of the surface layer constitutes a surface of the electrophotographic member; the surface of the electrophotographic member has a surface hardness measured by a nano-indentation method of 0.30 GPa or more and 0.50 GPa or less; the surface of the electrophotographic member has contact angles with n-hexadecane of γ1 and γ2, γ2 being a contact angle of the surface of the electrophotographic member that has been subjected to an accelerated discharge test and left for 24 hours after the accelerated discharge test, γ1 being a contact angle of the surface of the electrophotographic member that is not subjected to the accelerated discharge test; γ1 is 30.0° or more and 40.0° or less; and a percent change in the contact angle defined by the following calculation formula (1) is 10% or less.

Percent change(%)=(|γ1−γ2|/γ1)×100 Calculation formula (1)

To achieve recovery of toner releasability and high surface hardness, a binder resin having a dendrimer structure can be used as the binder resin.

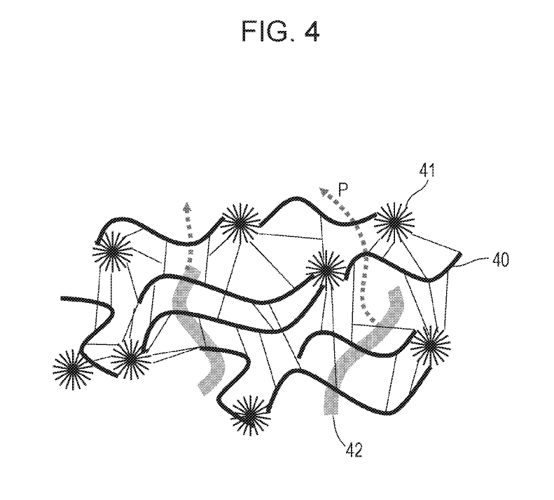

FIG. 4 schematically illustrates an embodiment of the surface layer. The surface layer contains a binder resin 40 having an acrylic skeleton and a modified silicone compound 42, and the binder resin 40 has a dendrimer structure 41. The dendrimer structure 41 is a highly branched structure in which branch molecules radially spread from the center in a branched manner. The density of a portion of the dendrimer structure 41 in the binder resin 40 is higher than that of typical binder resins because the Van der waals distance between the branch molecules is short. Therefore, the surface layer containing the binder resin 40 having a dendrimer structure 41 has hardness higher than that of the surface layer containing a typical binder resin. On the other hand, since the density is not relatively high in a portion away from the dendrimer structure 41 in the binder resin 40, the movement pathway P of the modified silicone compound 42 contained in the binder resin 40 to the surface is ensured. Thus, toner releasability satisfactorily recovers in the surface layer containing the binder resin 40 having a dendrimer structure 41.

According to an embodiment of the present invention, there can be provided an electrophotographic member which has good wear resistance and in which good toner releasability can be maintained for a long time. According to another embodiment of the present invention, there can be provided an electrophotographic image forming apparatus with which high-quality electrophotographic images are stably formed.

The electrophotographic member according to an embodiment of the present invention can be suitably used as an intermediate transfer body for electrophotographic image forming apparatuses in which a toner image formed on the first image carrying member is primarily transferred onto an intermediate transfer body and then the toner image primarily transferred onto the intermediate transfer body is secondarily transferred onto a second image carrying member to obtain an image.

### Electrophotographic Member

Hereafter, an electrophotographic member according to an embodiment of the present invention will be described.

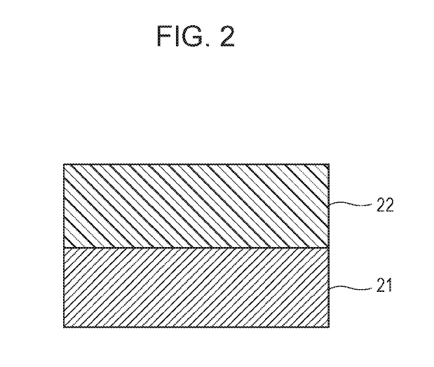

FIG. 2 is a schematic sectional view of the electrophotographic member according to an embodiment of the present invention. The electrophotographic member includes a substrate 21 and a surface layer 22 stacked on the substrate 21. Another layer may be disposed between the substrate 21 and the surface layer 22.

The electrophotographic member normally has, for example, a volume resistivity of 1.0×10⁶ Ω·cm or more and 1.0×10¹⁴ Ω·cm or less. The surface resistivity measured from the surface layer 22 side is, for example, 1.0×10⁶ Ω/□ or more and 1.0×10¹³ Ω/□ or less. When the electrophotographic member whose electrical resistances are set in the ranges of semiconductor regions described above is used as an intermediate transfer body, the transfer (primary transfer) of toner images from the electrophotographic photosensitive member and secondary transfer can be stably performed.

### Substrate

A substrate 21 will be described.

Typical examples of the shape of the substrate 21 include semiconductive films and cylindrical seamless belts obtained by adding a conducting agent to a resin and semiconductive roller-like bodies that use a metal shaft as a metal core.

A thermosetting resin or a thermoplastic can be used as the resin for the substrate 21. Examples of the thermoplastic resin include polycarbonate, polyvinylidene fluoride (PVdF), polyethylene, polypropylene, polymethylpentene-1, polystyrene, polyamide, polylactic acid (PLLA), polysulfone, polyarylate, polyethylene terephthalate, polybutylene terephthalate, polyethylene naphthalate, polybutylene naphthalate, polyphenylene sulfide, polyethersulfone, polyether nitrile, thermoplastic polyimide, polyether ether ketone, thermotropic liquid crystal polymer, and polyamic acid. Examples of the thermosetting resin include thermosetting polyimide, phenolic resin, polyester resin, amino resin, epoxy resin, melamine resin, thermosetting polyurethane resin, thermosetting acrylic resin, and fluorine-modified resin. These resins may be used alone or in combination of two or more as a blend or an alloy.

An electron-conducting substance, an ionic conducting substance, or both of them may be used as the conducting agent. Examples of the electron conducting substance include carbon black, antimony-doped tin oxide, titanium oxide, and conductive polymers such as polyaniline. Examples of the ionic conducting substance include sodium perchlorate, lithium, cationic or anionic surfactants, nonionic surfactants, and oligomer and polymer compounds having an oxyalkylene repeating unit.

The substrate 21 may also optionally contain an antioxidant, an ultraviolet absorber, a pH adjuster, a crosslinking agent, and a pigment.

A publicly known production method can be used as a method for producing the substrate 21. When a thermosetting resin such as polyimide is used as a resin for the substrate 21, the substrate 21 can be produced as a seamless belt by applying a liquid prepared by dispersing a conducting agent (e.g., carbon black) in a polyimide precursor or a soluble polyimide and a solvent using a centrifugal molding machine and performing firing. When a thermoplastic resin is used as a resin, the substrate 21 can be produced by performing extrusion. Specifically, first, a conducting agent (e.g., carbon black) and a resin, and optionally additives are mixed with each other and melt-kneaded using a biaxial kneader or the like to prepare a semiconductive pellet. Subsequently, the pellet is melt-extruded into a sheet-like shape, a film-like shape, or a seamless belt-like shape to obtain a substrate 21. The substrate 21 can also be molded by performing thermal press or injection molding. Furthermore, a semiconductive film may be molded by stretching blow using a molded preform.

The thickness of the substrate 21 is 10 μm or more and 500 μm or less and particularly 30 μm or more and 150 μm or less.

### Surface Layer

Subsequently, the surface layer 22 will be described. The surface layer 22 contains a binder resin 40 having an acrylic skeleton and a modified silicone compound 42 having a polyether group and a hydroxyl group in a molecule.

The surface layer 22 (the surface of the electrophotographic member) satisfies the following conditions (i) and (ii).

(i) When the contact angle with n-hexadecane of the surface of the electrophotographic member that has been subjected to an accelerated discharge test and left for 24 hours after the accelerated discharge test is assumed to be γ2 and the contact angle with n-hexadecane of the surface of the electrophotographic member that is not subjected to the accelerated discharge test is assumed to be γ1, γ1 is 30.0° or more and 40.0° or less and the percent change in the contact angle defined by the following calculation formula (1) is 10% or less.

Percent change(%)=(|γ1−γ2|/γ1)×100 Calculation formula (1)

(ii) The surface hardness measured by a nano-indentation method is 0.30 GPa or more and 0.50 GPa or less.

### Binder Resin Having Acrylic Skeleton

The binder resin 40 (hereafter also referred to as an “acrylic resin”) having an acrylic skeleton is, for example, a polyacrylic acid ester resin or a polymethacrylic acid ester resin. The binder resin 40 is a polymer constituted by a single polymerizable compound or a random copolymer, a graft copolymer, or a block copolymer constituted by a plurality of polymerizable compounds.

Examples of the polymerizable compound serving as a raw material for the binder resin 40 include acrylic monomers such as dipentaerythritol hexaacrylate, dipentaerythritol pentaacrylate, dipentaerythritol polyacrylate, pentaerythritol tetraacrylate, trimethylolpropane trimethacrylate, isoamyl acrylate, lauryl acrylate, stearyl acrylate, ethoxydiethylene glycol acrylate, phenoxyethyl acrylate, phenoxydiethylene glycol acrylate, tetrahydrofurfuryl acrylate, and isobornyl acrylate.

The binder resin 40 has, for example, a dendrimer structure 41. The binder resin 40 having a dendrimer structure 41 can be obtained by adding a dendrimer acrylate together with the above-described acrylic monomer. The dendrimer acrylate is a tree-like molecule having a branched structure in which branch molecules having an acrylic group at their ends are radially arranged. The acrylic group at the end of the dendrimer acrylate is reacted through irradiation with active energy rays, and the dendrimer acrylate and the acrylic monomer form the binder resin 40.

In general, the number of branches of a dendrimer is expressed as the number of generations. The number of generations of the dendrimer acrylate is, for example, 3 or more. When the binder resin 40 contains a dendrimer acrylate whose number of generations is 3 or more, a sufficiently high surface hardness that can endure the load in an electrophotographic process is achieved.

Various methods are known as a method for synthesizing such a dendrimer acrylate, and the number of generations per molecule and the molecular weight can be uniformly adjusted with high precision. Note that the dendrimer acrylate does not necessarily have a precisely controlled number of generations or does not necessarily have a uniform molecular size.

### Modified Silicone Compound

The silicone compound 42 has a polyether group and a hydroxyl group in a molecule.

The modified silicone compound 42 has a polyether group and a hydroxyl group in a molecule, and thus is stably retained in the binder resin 40 having an acrylic skeleton. This is because the polyether group in the modified silicone compound 42 has a high affinity for an acrylic skeleton in the binder resin 40, and the hydroxyl group forms a hydrogen bond with a polarized atom present in the binder resin 40, such as carbonyl oxygen.

In the electrophotographic member containing such a modified silicone compound 42, it is believed that even if the modified silicone compound 42 present on the surface of the surface layer 22 is decomposed by discharging, the modified silicone compound 42 retained inside the surface layer 22 is supplied to the surface, and thus the toner releasability recovers. It is generally known that in order to minimize the energy in a system, a compound having a small surface energy, such as the modified silicone compound 42, moves to an interface with air where the energy becomes most unstable and is unevenly distributed at the surface of the surface layer 22. When the modified silicone compound 42 unevenly distributed at the surface is deactivated by discharging, the surface energy of the uppermost surface increases. To stabilize the system again, the modified silicone compound 42 is supplied from the inside of the surface layer 22. As a result, it is believed that the toner releasability on the surface recovers and good toner releasability can be maintained.

The content of the polyether group in the modified silicone compound 42 is, for example, 20 parts by mass or more and 40 parts by mass or less based on 100 parts by mass of a polysiloxane serving as a main skeleton of the modified silicone compound 42. When the content of the polyether group is 20 parts by mass or more, the modified silicone compound 42 can be further dissolved with the binder resin 40 well. When the content of the polyether group is 40 parts by mass or less, the content of the polysiloxane in the modified silicone compound 42 is sufficiently high, and thus good toner releasability of the surface layer 22 is achieved.

The modified silicone compound 42 also has a hydroxyl group to improve the retention inside the surface layer 22. It has been found that a polyether-modified silicone compound not having a hydroxyl group exhibits high molecular motion in the binder resin 40 and thus bleeds to the surface of the electrophotographic member, which contaminates members that are in contact with the electrophotographic member. The hydroxyl value of the modified silicone compound 42 is, for example, 30 mgKOH/g or more and 70 mgKOH/g or less. By setting the hydroxyl value of the modified silicone compound 42 within the above range, the modified silicone compound 42 can be stably retained in the acrylic resin through a hydrogen bond.

The hydroxyl value herein can be determined by acetylating a hydroxyl group in a monomer to be measured using a weighed acetic anhydride (acetylating agent) having a known concentration and titrating an acetic anhydride not used for the acetylation with a potassium hydroxide solution. Herein, the amount of the hydroxyl group contained in 1 g of a sample is expressed in units of mg of potassium hydroxide required for the titration.

The modified silicone compound 42 has, for example, a structure represented by formula (1) or (3) below.

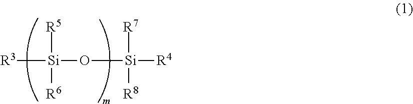

In the formula (1), m represents an integer of 2 or more and 300 or less, R³ to R⁸ each represent a hydrocarbon group having 1 to 3 carbon atoms or a structure represented by chemical formula (2) below, and at least one of R³ to R⁸ represents the structure represented by the formula (2). In particular, for example, m represents an integer of 60 or more and 200 or less, R³ and R⁴ represent the structure represented by the formula (2), and R⁵ to R⁸ represent a methyl group.

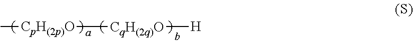

In the formula (2), p and q each independently represent an integer of 2 or more and a and b represent an integer of 1 or more. In particular, for example, p represents an integer of 2 or more and 6 or less, p and q each independently represent 2 or 3, and a and b each independently represent an integer of 1 or more and 50 or less.

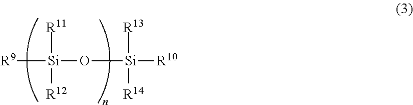

In the formula (3), n represents an integer of 2 or more and 300 or less, R⁹ to R¹⁴ each represent a hydrocarbon group having 1 to 3 carbon atoms or a structure represented by chemical formula (4) below, and at least one of R⁹ to R¹⁴ represents the structure represented by the formula (4). In particular, for example, n represents an integer of 60 or more and 200 or less, R⁹ and R¹⁰ represent the formula (4), and R¹¹ to R¹⁴ represent a methyl group.

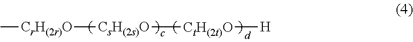

In the formula (4), r, s, and t each independently represent an integer of 2 or more, c and d represent an integer of 1 or more. For example, r preferably represents an integer of 2 or more and 6 or less and more preferably 3, s and t preferably each independently represent 2 or 3, and c and d preferably each independently represent an integer of 1 or more and 50 or less and more preferably an integer of 1 or more and 15 or less.

The modified silicone compound 42 particularly has a structure represented by formula (5) below.

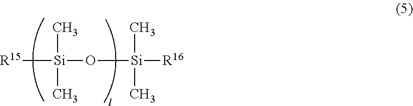

In the formula (5), R¹⁵ and R¹⁶ each independently represent a structure represented by formula (6) below, and l represents an integer of 2 or more and 300 or less and, for example, an integer of 60 or more and 200 or less.

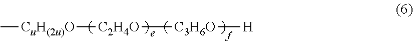

In the formula (6), u represents an integer of 2 or more and 6 or less, and e and f each independently represent an integer of 1 or more and 50 or less and, for example, each independently represent an integer of 1 or more and 15 or less.

The weight-average molecular weight (Mw) of the modified silicone compound 42 is 5000 or more and 20000 or less and, in particular, 6000 or more and 15000 or less. The self-recovery rate of the modified silicone compound 42 is known to be dependent on the weight-average molecular weight of the modified silicone compound 42. This may be because the modified silicone compound easily moves from the inside of the surface layer 22 to the surface as the weight-average molecular weight of the modified silicone compound decreases. That is, the modified silicone compound 42 having a weight-average molecular weight Mw of 20000 or less has a sufficiently high moving speed in the binder resin 40 and thus the toner releasability quickly recovers. Therefore, the electrophotographic member can exhibit good toner releasability even if being subjected to discharging for a long time. In order to sufficiently achieve good toner releasability of the surface, for example, a compound having a weight-average molecular weight Mw of 5000 or more is used as the modified silicone compound 42.

In an embodiment of the present invention, the weight-average molecular weight Mw is measured by a method for measuring the molecular weight distribution using gel permeation chromatography (GPC) under the following conditions. A column is stabilized in a heat chamber at 40° C., and toluene serving as a solvent is caused to flow through the column at 40° C. at a flow rate of 1 mL/min. About 100 μL of a toluene sample solution of a non-reactive silicone compound prepared so as to have a sample concentration of 0.3 parts by mass is injected and the measurement is performed. In the measurement of the molecular weight of the sample, the molecular weight distribution of the sample is calculated from the relationship between the retention time and the logarithmic value of a calibration curve made using some monodisperse polystyrene standard samples (trade name: TSKgel Standard Polystyrene “0005202” to “0005211”, manufactured by Tosoh Corporation). The GPC instrument is a GPC gel permeation chromatography analyzer (trade name: HLC8220, manufactured by Tosoh Corporation) and the detector is a differential refractometer detector (trade name: RI-8020, manufactured by Tosoh Corporation). For the column, three commercially available polystyrene gel columns (trade name: Shodex GPC LF-804, manufactured by SHOWA DENKO K.K.) are combined.

The content of the modified silicone compound 42 in the surface layer 22 is, for example, 5 mass % or more and 60 mass % or less and, in particular, 20 mass % or more and 60 mass % or less based on the binder resin 40 in the surface layer 22. In the case where the content of the modified silicone compound 42 is 5 mass % or more, when the surface layer 22 is subjected to discharge degradation, a sufficient amount of the modified silicone compound 42 used for recovery of the toner releasability can be retained inside the surface layer 22. When the content of the modified silicone compound 42 is 60 mass % or less, a decrease in the surface hardness of the electrophotographic member can be suppressed.

The molecular structure of the modified silicone compound 42 and the structures of a silicone moiety and a polyether moiety can be identified by isolating the modified silicone compound 42 from the surface layer 22 by extraction and then performing an analysis such as pyrolysis GC/MS, NMR, IR, or ultimate analysis. The content of the modified silicone compound 42 in the surface layer 22 can be determined by measuring the mass of the modified silicone compound 42 extracted from the surface layer 22 and comparing the masses of the modified silicone compound 42 and the surface layer 22. A solvent that does not react with the modified silicone compound 42 needs to be selected as a solvent used for the extraction of the modified silicone compound 42. Suitable examples of the solvent include tetrahydrofuran (THF), ethyl acetate, and methyl ethyl ketone (MEK). The subsequent isolation is performed by removing the solvent using a rotatory evaporator and isolating the modified silicone compound 42 by chromatography.

Contact Angle with n-Hexadecane

The toner releasability on the surface of the electrophotographic member can be evaluated by measuring the oil repellency of the surface layer 22.

In general, the toner releasability on the surface of the electrophotographic member is improved by imparting high oil repellency to the surface of the electrophotographic member. This is because a wax component that adheres to the surface of toner particles suppresses the adhesion of the toner particles to the surface of the electrophotographic member. Therefore, the toner releasability tends to improve as the oil repellency of the surface of the electrophotographic member increases.

The oil repellency is generally evaluated by measuring the contact angle on the surface of the surface layer 22 by using n-hexadecane, which is an oil-based liquid, as a probe liquid. For the measured contact angle with n-hexadecane, a large contact angle indicates good toner releasability.

The contact angle γ1 with n-hexadecane on the surface of the electrophotographic member that is not subjected to an accelerated discharge test described below is in the range of 30.0° or more and 40.0° or less. When the contact angle γ1 with n-hexadecane is 30.0° or more, good releasability can be achieved. To set the contact angle γ1 with n-hexadecane to be 30.0° or more, as described above, the content of the modified silicone compound 42 in the surface layer 22 is, for example, 5 mass % or more and, in particular, 20 mass % or more based on the binder resin 40 in the surface layer 22. If the modified silicone compound 42 is used, the contact angle γ1 with n-hexadecane is 40.0° or less.

### Accelerated Discharge Test

In the electrophotographic member, even if the modified silicone compound 42 present on the surface of the surface layer 22 is deactivated by discharging, the modified silicone compound 42 retained inside the surface layer 22 moves to a top layer of the surface layer 22, and thus the toner releasability recovers. Such recovery of the toner releasability can be confirmed by performing an accelerated discharge test.

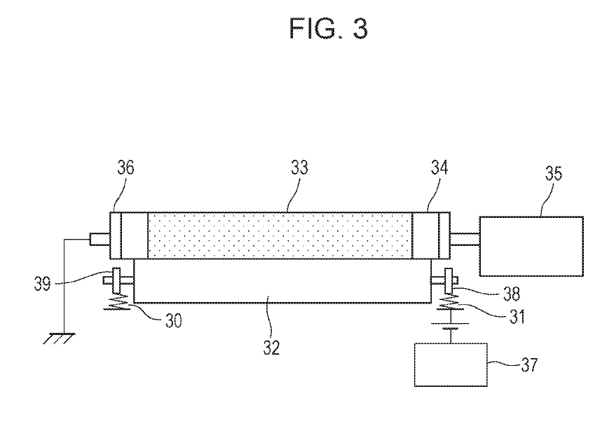

In an embodiment of the present invention, the accelerated discharge test is performed as follows. As illustrated in FIG. 3, an insulating tape 34 for preventing leakage is wound around a metal roller 36 made of aluminum and having a circumference of about 96 mm. A sample 33 of the electrophotographic member that is cut so as to have a width of about 9 mm is wound around the central portion of the metal roller 36 so that the front surface of the sample 33 faces outward. The metal roller 36 around which the sample 33 has been wound is brought into contact with a facing roller 32 (NBR sponge roller) having a circumference of about 96 mm using a pressurizing spring 30 (2.5 kgf) attached to a bearing (insulative) 39 and a pressurizing spring 31 (2.5 kgf) attached to a bearing (conductive) 38. The metal roller 36 is rotated at a rotational speed of 160 rpm using a driving motor 35 while pressure is applied by the pressurizing springs. A voltage of 6.5 kV is applied between the metal roller 36 and the facing roller 32 from a high-voltage power source 37 (trade name: “MODEL 610E”, manufactured by TREK JAPAN). In this state, a discharge test is performed for 10 hours.

The contact angle with n-hexadecane on the surface is measured for the electrophotographic member that is not subjected to the accelerated discharge test and the electrophotographic member that has been subjected to an accelerated discharge test and left for 24 hours after the accelerated discharge test. The percent change in the contact angle γ2 with n-hexadecane on the surface of the electrophotographic member that has been subjected to an accelerated discharge test and left for 24 hours after the accelerated discharge test relative to the contact angle γ1 with n-hexadecane on the surface of the electrophotographic member that is not subjected to the accelerated discharge test is calculated based on the calculation formula (1) below.

Percent change(%)=(|γ1−γ2|/γ1)×100 Calculation formula (1)

The percent change in the contact angle with n-hexadecane of the electrophotographic member is 10% or less.

This comes from the recognition, obtained as a result of studies conducted by the present inventors, that when the percent change in the contact angle with n-hexadecane before and after the accelerated discharge test is within 10%, the practical durability for intermediate transfer bodies is sufficiently high.

### Surface Hardness of Surface Layer

It is important that the surface hardness of the surface layer 22 is 0.30 GPa or more and 0.50 GPa or less.

When the surface layer 22 has a surface hardness of 0.30 GPa or more, abrasion and formation of scratches that are caused by sliding with a sliding member (e.g., a cleaning blade) or contact of toners and external additives present between the sliding member and the surface layer 22 can be suppressed. When the surface layer 22 has a surface hardness of 0.50 GPa or less, the molecular movement of the modified silicone compound 42 inside the surface layer 22 is not easily inhibited, and thus good toner releasability can be maintained.

The surface hardness of the surface layer 22 can be measured by a nano-indentation method. The measurement method for the surface hardness will be described in detail in Examples.

The surface hardness of the surface layer 22 can be adjusted by controlling the types of acrylic monomer and dendrimer acrylate used and the content of the dendrimer acrylate in the binder resin 40. That is, the content of each material may be determined in accordance with the types of acrylic monomer and dendrimer acrylate used. Note that when the surface hardness is increased, the percent change in the contact angle with n-hexadecane sometimes decreases. Therefore, the types and content may be determined so that the surface hardness and the percent change in the contact angle with n-hexadecane are within the above-described ranges.

Specifically, an increase in the number of functional groups of the acrylic monomer tends to increase the surface hardness of the surface layer 22 and the percent change in the contact angle with n-hexadecane. The number of functional groups is, for example, 3 or more and 8 or less and, in particular, 3 or more and 6 or less.

Furthermore, an increase in the content of the dendrimer acrylate in the binder resin 40 tends to increase the surface hardness of the surface layer 22 and the percent change in the contact angle with n-hexadecane. The content of the dendrimer acrylate in the binder resin 40 is, for example, 20 parts by mass or more and 100 parts by mass or less and, in particular, 30 parts by mass or more and 80 parts by mass or less based on 100 parts by mass of the acrylic monomer.

For example, in the case where dipentaerythritol hexaacrylate (DPHA), which is a hexafunctional acrylate and a dendrimer acrylate (“SIRIUS-501” manufactured by OSAKA ORGANIC CHEMICAL INDUSTRY Ltd., viscosity: 39.6 mPa·s/25° C., solvent: PMGPA, hydroxyl value: 0.13 KOHmg/g, weight-average molecular weight Mw: 20400) are used, when 20 parts by mass or more and 100 parts by mass or less of the dendrimer acrylate is added to 100 parts by mass of the acrylic monomer, the surface hardness and the percent change in the contact angle with n-hexadecane can satisfy the above-described ranges.

### Method for Producing Electrophotographic Member

Hereafter, a method for producing an electrophotographic member according to an embodiment of the present invention will be specifically described using a belt-shaped intermediate transfer body as an example.

A modified silicone compound 42 having a polyether group and a hydroxyl group in a molecule, additives, a polymerization initiator, and a solvent are mixed with a raw material for a binder resin 40 and thoroughly stirred to prepare a mixed dispersion liquid. Herein, Irgacure (Ciba-Geigy Japan Limited) serving as a photoinitiator can be used as the polymerization initiator. The additives may be a conducting agent, filler particles, a coloring agent, and a leveling agent.

The resulting mixed dispersion liquid is applied onto a belt-shaped substrate 21 by a coating method such as ring coating, dip coating, spray coating, roll coating, or spin coating. Subsequently, the coating film is dried at 60° C. to 90° C. for several minutes to distill off the solvent. Then, the coating film is cured using an apparatus for irradiation with active energy rays such as ultraviolet rays or electron beams. Thus, a surface layer 22 is formed.

The active energy rays are particularly ultraviolet rays. A low-pressure mercury lamp or a metal halide lamp that emits light having a wavelength of 260 nm to 360 nm can be suitably used as an ultraviolet-ray source. The integral light amount of the ultraviolet rays applied is dependent on the types of acrylic monomer and dendrimer acrylate used, the contents of the acrylic monomer and the dendrimer acrylate in the surface layer 22, the thickness of the surface layer 22, the desired surface hardness, and the work size. The integral light amount is, for example, 450 mJ/cm² or more and 3,000 mJ/cm² or less.

The thickness of the surface layer 22 can be suitably adjusted by controlling the film forming conditions such as the solid content of the mixed dispersion liquid and the film formation rate. The thickness of the surface layer 22 is, for example, 1 μm or more in view of abrasion and wear under actual durability conditions and 10 μm or less in view of bending resistance in stretching a belt. If higher bending resistance is required, the thickness is, for example, 5 μm or less.

### Electrophotographic Image Forming Apparatus

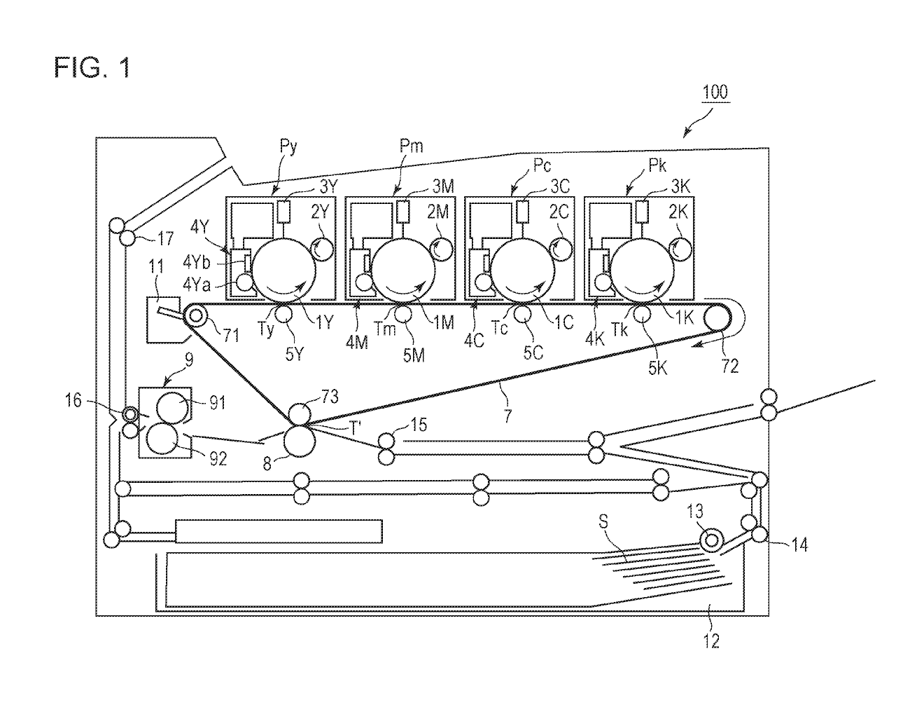

An electrophotographic image forming apparatus 100 illustrated in FIG. 1 is a color electrophotographic image forming apparatus (color laser printer). In this electrophotographic image forming apparatus 100, image forming units Py, Pm, Pc, and Pk for yellow (Y), magenta (M), cyan (C), and black (K) are arranged in this order along a flat portion of an intermediate transfer belt 7 serving as an intermediate transfer body in the moving direction of the intermediate transfer belt 7. The image forming units Py, Pm, Pc, and Pk respectively include electrophotographic photosensitive members 1Y, 1M, 1C, and 1K, charging rollers 2Y, 2M, 2C, and 2K, laser exposure devices 3Y, 3M, 3C, and 3K, developing units 4Y, 4M, 4C, and 4K, and primary transfer rollers 5Y, 5M, 5C, and 5K. Since each of the image forming units has the same basic structure, only the yellow image forming unit Py will be described in detail.

The yellow image forming unit Py includes a drum-shaped electrophotographic photosensitive member (hereafter also referred to as a “photosensitive drum” or a “first image carrying member”) 1Y as an image carrying member. The photosensitive drum 1Y includes an aluminum cylinder as a base, and is formed by stacking a charge generating layer, a charge transporting layer, and a surface protective layer on the aluminum cylinder in this order.

The yellow image forming unit Py also includes a charging roller 2Y serving as a charging device. By applying a charging bias to the charging roller 2Y, the surface of the photosensitive drum 1Y is uniformly charged.

A laser exposure device 3Y serving as an image exposure device is disposed above the photosensitive drum 1Y. The laser exposure device 3Y is configured to form a yellow electrostatic latent image on the surface of the photosensitive drum 1Y by performing scanning exposure on the surface of the uniformly charged photosensitive drum 1Y on the basis of the image information.

The electrostatic latent image formed on the photosensitive drum 1Y is developed by a developing unit 4Y, which is a developing device, using a toner serving as a developing agent. That is, the developing unit 4Y includes a developing roller 4Ya serving as a developing agent carrying member and a regulating blade 4Yb serving as a member for regulating the amount of the developing agent, and contains a yellow toner serving as a developing agent. The developing roller 4Ya to which the yellow toner has been supplied is brought into lightly pressure-contact with the photosensitive drum 1Y in a developing portion and is rotated in a forward direction at a speed different from that of the photosensitive drum 1Y. The yellow toner conveyed to the developing portion by the developing roller 4Ya adheres to the electrostatic latent image formed on the photosensitive drum 1Y by applying a developing bias to the developing roller 4Ya. Thus, a visible image (yellow toner image) is formed on the photosensitive drum 1Y.

The intermediate transfer belt 7 is stretched by a driving roller 71, a tension roller 72, and a driven roller 73 and is moved (rotated) in a direction indicated by an arrow in FIG. 1 while being in contact with the photosensitive drum 1Y.

The yellow toner image that has been formed on the photosensitive drum (first image carrying member) and has reached a primary transfer portion Ty is primarily transferred onto the intermediate transfer belt 7 by a primary transfer member (primary transfer roller 5Y) disposed so as to face the photosensitive drum 1Y with the intermediate transfer belt 7 disposed therebetween.

Similarly, the above image-forming operation is performed in each of the units Pm, Pc, and Pk for magenta (M), cyan (C), and black (K) with the movement of the intermediate transfer belt 7 to superimpose four-color toner images of yellow, magenta, cyan, and black on the intermediate transfer belt 7. The four-color toner layer is conveyed to a secondary transfer portion T′ with the movement of the intermediate transfer belt 7, and the entire four-color toner layer is transferred by a secondary transfer roller 8 serving as a secondary transfer device onto a recording medium S (hereafter also referred to as a “second image carrying member”) conveyed at a predetermined timing. In this secondary transfer, a transfer voltage of several kilovolts is normally applied to achieve a sufficiently high transfer ratio, but this sometimes causes discharge near the transfer nip. This discharge is one of causes of degrading the surface characteristics of the intermediate transfer body.

The recording medium S is supplied from a cassette 12 containing recording media S to a conveyance path by a pick-up roller 13. The recording medium S supplied to the conveyance path is conveyed to the secondary transfer portion T′ by a pair of conveyance rollers 14 and a pair of registration rollers 15 in synchronism with the four-color toner image transferred onto the intermediate transfer belt 7.

The toner image transferred onto the recording medium S is fixed by a fixing unit 9, and is formed as, for example, a full-color image. The fixing unit 9 includes a fixing roller 91 including a heating unit and a pressurizing roller 92. In the fixing unit 9, an unfixed toner image on the recording medium S is fixed by being heated and pressurized. Subsequently, the recording medium S is discharged from the image forming apparatus by a pair of conveyance rollers 16, a pair of discharge rollers 17, and the like.

A cleaning blade 11 serving as a cleaning member for the intermediate transfer belt 7 is disposed downstream of the secondary transfer portion T′ in the driving direction of the intermediate transfer belt 7. In the secondary transfer portion T′, the cleaning blade 11 removes a residual toner left on the intermediate transfer belt 7 without being transferred onto the recording medium S.

As described above, an electrical transfer process of toner images is repeatedly performed from the photosensitive member to the intermediate transfer belt and from the intermediate transfer belt to the recording medium. Furthermore, recording is repeatedly performed on many recording media and thus the electrical transfer process is further repeatedly performed.

By using the electrophotographic member as an intermediate transfer belt for the electrophotographic image forming apparatus, a time-related change in transfer efficiency (secondary transfer efficiency) of toner images from an intermediate transfer belt to a recording medium such as paper is suppressed. As a result, high-quality electrophotographic images can be formed for a long time.

### EXAMPLES

Hereafter, Examples and Comparative Examples of the present invention will be described. In each of Examples and Comparative Examples, materials for a mixed dispersion liquid are materials diluted or dispersed in a solvent. The amount (parts by mass) of each material used is an amount based on the nonvolatile content unless otherwise specified, and thus means an amount excluding the solvent (volatile component). Prior to the description of Examples, the evaluation methods for produced intermediate transfer body will be described.

### 1. Evaluation of Toner Releasability

The toner releasability of intermediate transfer belts according to Examples and Comparative Examples was evaluated by measuring the contact angle with n-hexadecane of a surface layer. The contact angle was measured with a contact angle meter (“DROPMASTER 500” manufactured by Kyowa Interface Science Co., Ltd.) using n-hexadecane as a probe liquid. The amount of n-hexadecane dropped was 1 μL and the measurement time was 5 seconds.

### 2. Measurement of Surface Hardness of Surface Layer

The surface hardness of the surface layer of each of the intermediate transfer belts according to Examples and Comparative Examples was measured by a nano-indentation method.

Each of the whole intermediate transfer belts according to Examples and Comparative Examples was cut into a size of about 5 mm×5 mm with a cutter. Subsequently, a sample stage heated to about 100° C. was coated with a wax (CRYSTALBOND 509, manufactured by AREMCO PRODUCTS, INC.), and the cut belt was attached to the sample stage. The belt was fixed on the sample stage by decreasing the temperature of the sample stage to room temperature. Thus, the measurement sample was prepared.

In the prepared measurement sample, the surface hardness was measured at freely-selected 12 points on the surface of the surface layer. The highest surface hardness and the lowest surface hardness were removed, and the arithmetic mean of the surface hardnesses at 10 points was calculated.

The measurement was performed by a continuous stiffness measurement (CSM) mode with a DCM head using a nanoindenter G200 manufactured by Agilent Technologies, Inc. and a Berkovich indenter. For the measurement principle of the CSM mode, refer to Journal of Materials Research, Vol. 7, No. 6, pp. 1564-1583. The measurement conditions were as follows.

### Measurement Conditions

### Delta X For Finding Surface: −50 (μm)

### Delta Y For Finding Surface: −50 (μm)

Allowable Drift Rate: 0.5 (nm/s)

### Maximum Thermal Drift Time: 3.0 (h)

### Surface Approach Distance: 1000 (nm)

### Surface Approach Velocity: 10 (nm)

### Surface Detect Stiffness Criteria: 200 N/m

### Depth Limit: 2000 (nm)

### Strain Rate Target: 0.05 (1/s)

### Harmonic Displacement Target: 1.0 (nm)

### Frequency Target: 75.0 (Hz)

Measurement temperature: 25° C.

The measurement region of the surface hardness is a region of 10% or more and 20% or less from the uppermost surface of the surface layer in the thickness direction. A region of less than 10% from the uppermost surface of the surface layer in the thickness direction, which is a region near the uppermost surface of the electrophotographic member, is easily affected by the measurement environment such as indenter vibration. A region of more than 20% from the uppermost surface of the surface layer in the thickness direction is easily affected by the substrate. Therefore, these regions are excluded from the calculation.

### 3. Evaluation of Bleeding

In each of the intermediate transfer belts according to Examples and Comparative Examples, the silicon content in the silicone compound on the surface of the surface layer of the intermediate transfer belt was measured over time by electron spectroscopy for chemical analysis (ESCA). The presence or absence of bleeding was judged by observing a change (increase) in the silicon content on the surface of the surface layer. Specifically, the following was performed.

First, the silicon content on the surface was measured using an X-ray photoelectron spectrometer (trade name: Quantum-200, manufactured by ULVAC-PHI, Inc.) immediately after the intermediate transfer belt was produced. Then, after the intermediate transfer belt was left to stand for 24 hours in a high-temperature and high-humidity environment (40° C. and 95% RH) where bleeding easily occurs, the silicon content on the surface was measured again. The case where the silicon content on the surface of the intermediate transfer belt left to stand in a high-temperature and high-humidity environment was increased by 5 atm % or more compared with the silicon content on the surface of the intermediate transfer belt immediately after the production was judged to be “generation of bleeding”.

The evaluation criteria in Table 3 are as follows.

Rank “A”: No generation of bleeding
Rank “C”: Generation of bleeding

### 4. Evaluation of Discharge Durability

In each of the intermediate transfer belts according to Examples and Comparative Examples, the above-described accelerated discharge test was performed to evaluate the discharge durability.

The contact angle with n-hexadecane on the surface of the intermediate transfer belt was measured before the accelerated discharge test and 24 hours after the accelerated discharge test. The percent change relative to the contact angle with n-hexadecane before the accelerated discharge test was calculated, and the evaluation was performed based on the following evaluation criteria.

Rank “A”: The percent change in contact angle with n-hexadecane was 10% or less.
Rank “C”: The percent change in contact angle with n-hexadecane was more than 10%.

### 5. Evaluation of Image

In order to evaluate the toner releasability of each of the intermediate transfer belts according to Examples and Comparative Examples, each of the intermediate transfer belts according to Examples and Comparative Examples was installed instead of an intermediate transfer belt made of polyimide and installed in a full-color electrophotographic image forming apparatus (trade name: Image RUNNER ADVANCE C5051, manufactured by CANON KABUSHIKI KAISHA).

An image in which the alphabet letter “E” with a font size of 4 points was formed at a printing density of 2% (hereafter referred to as an “E letter image”) was formed on an A4 plain paper (trade name: CS814, manufactured by CANON KABUSHIKI KAISHA). The E letter image was printed on 50,000 sheets. The image was formed using a black developing agent included in a print cartridge of the electrophotographic image forming apparatus. The image was printed in a normal-temperature and normal-humidity environment (25° C. and 55% RH).

After the printing of the image, a secondary color solid image was printed using developing agents of cyan and magenta, and the printed solid image was evaluated as follows. The solid image was scanned at a resolution of 600 dpi with image correction: OFF using a scanner (trade name: CanoScan 9000F, manufactured by CANON KABUSHIKI KAISHA), and trimmed so as to have a size of 2,550×2,550 pixels (approximately 10.8×10.8 cm). The obtained image was visually observed at a display magnification of 200%, and whether the image unevenness was observed was evaluated based on the following criterial.

Rank “A”: Good image with no color unevenness
Rank “B”: Good image with almost no color unevenness
Rank “C”: Good image next to Rank B
Rank “D”: Color unevenness is observed.

### Example 1

An endless belt-shaped intermediate transfer belt made of polyimide resin in a full-color electrophotographic image forming apparatus (trade name: Image RUNNER ADVANCE C5051, manufactured by CANON KABUSHIKI KAISHA) was used as a substrate.

One hundred parts by mass of dipentaerythritol hexaacrylate (hexafunctional acrylate, trade name: KAYARAD DPHA, manufactured by Nippon Kayaku Co., Ltd.) and 50 parts by mass of dendrimer acrylate (trade name: SIRIUS-501, manufactured by OSAKA ORGANIC CHEMICAL INDUSTRY Ltd.) were prepared as raw materials for a binder resin. Five parts by mass of polyether-hydroxyl group co-modified silicone (weight-average molecular weight Mw=15000, viscosity (25° C.): 400 mm²/s, hydroxyl value: 50 KOHmg/g, trade name: X-22-6266, manufactured by Shin-Etsu Chemical Co., Ltd.), and 25 parts by mass of a conductive metal oxide (gallium-doped zinc oxide) manufactured by C. I. Kasei Company, Limited and 3 parts by mass of a photoinitiator (trade name: Irgacure 184, manufactured by Ciba-Geigy Japan Limited) serving as additives were prepared based on 100 parts by mass in total of the dipentaerythritol hexaacrylate and the dendrimer acrylate. They were all mixed with each other. The resulting mixture was diluted with methyl isobutyl ketone so as to have a solid content of 25% to obtain a dispersion liquid. The polyether-hydroxyl group co-modified silicone is a modified silicone compound having the structure represented by the formula (1).

The dispersion liquid was applied onto the intermediate transfer belt by slit coating to form a coating film. The coating film was dried at 60° C. for 2 minutes. Subsequently, the coating film was cured by irradiation with ultraviolet rays to form a surface layer. Thus, an “intermediate transfer belt No. 1” according to Example 1 was produced. An ultraviolet lamp (trade name: UE06/81-3, manufactured by EYE GRAPHICS CO., LTD.) was used as an ultraviolet source, and the irradiation with ultraviolet rays was performed until the integral light amount reached 1200 mJ/cm². The thus-produced intermediate transfer belt No. 1 was used for various evaluations. Table 3 shows other evaluation result.

### Examples 2 to 10

Intermediate transfer belt Nos. 2 to 10 were produced in the same manner as in Example 1, except that when the mixed dispersion liquid was prepared, any of the types of raw materials for the binder resin, the amount of the dendrimer acrylate used, and the type and amount of the modified silicone compound used was changed to the conditions listed in Table 1. Then, each evaluation was performed. Table 3 shows the evaluation results.

The trade name “X-22-4952” (weight-average molecular weight Mw=6000, viscosity (25° C.): 100 mm²/s, hydroxyl value: 50 mgKOH/g) listed in Table 1 is a modified silicone compound having the structure represented by the formula (1) with R⁵ to R⁸ each representing a methyl group and R³ and R⁴ representing the structure represented by the formula (2).

### Comparative Examples 1 to 4

Intermediate transfer belt Nos. 11 to 14 were produced in the same manner as in Example 2, except that when the mixed dispersion liquid was prepared, compounds listed in Table 2 were used as the modified silicone compound. Then, each evaluation was performed. Table 3 shows the evaluation results.

In the evaluation results, the test result of the discharge durability of the intermediate transfer belt No. 11 according to Comparative Example 1 was Rank “C”. This may be because, in the intermediate transfer belt No. 11, the modified silicone compound does not have a hydroxyl group and thus the retention of the modified silicone compound in the binder resin is poor. If the retention of the modified silicone compound in the binder resin is poor, the modified silicone compound easily moves to the surface of the belt and thus almost all the modified silicone compound contained in the intermediate transfer belt bleeds during the image printing test of 50,000 sheets. As a result, it is believed that after the image printing of 50,000 sheets, the modified silicone compound used for recovery of the contact angle on the surface of the belt was not left in the binder resin.

In the intermediate transfer belt Nos. 12 and 14 according to Comparative Examples 2 and 4, the coating film was not satisfactorily cured. Even when the UV output was increased and the curing time was increased, the surface hardness that can provide the durability in the electrophotographic process was not achieved. This may be because the modified silicone compound does not have a polyether group and thus has low compatibility with the binder resin. In Table 3, “F” indicates that the surface hardness could not be measured.

The test result of the discharge durability of the intermediate transfer belt No. 13 according to Comparative Example 3 was Rank “C”. This may be because the modified silicone compound according to Comparative Example 3 has an acrylic group, which is a reactive group, and thus the modified silicone compound reacts with the binder resin in the curing process and is chemically fixed in the binder resin. The silicone compound fixed in the binder resin present inside the surface layer does not easily move to the surface. Therefore, the toner releasability of the surface layer did not recover.

### Reference Examples 1 and 2

Intermediate transfer belt Nos. 15 and 16 were produced in the same manner as in Example 2, except that when the mixed dispersion liquid was prepared, only acrylic monomers listed in Table 2 were added as the raw material for the binder resin without adding the dendrimer acrylate. Then, each evaluation was performed. Table 3 shows the evaluation results.

Although the evaluation results of the discharge durability of the intermediate transfer belt Nos. 15 and 16 according to Reference Examples 1 and 2 were Rank “A”, the evaluation results of image quality after the printing of 50,000 sheets were Rank “C” because of generation of color unevenness. This may be because the dendrimer acrylate was not added to the binder resin and thus a desired surface hardness was not achieved in the electrophotographic member, which easily caused abrasion and formation of scratches on the surface of the transfer belt.

TABLE 1

| | Binder resin | | | Modified silicone | |
|---|---|---|---|---|---|
| | Acrylic monomer | Dendrimer acrylate | | compound | |
| | Type | Type | Content*1 | Type | Content*2 |
| Example 1 | KAYARAD DPHA | SIRIUS-501 | 50 | X-22-6266 | 5 |
| | manufactured by | manufactured | | manufactured | |
| | Nippon Kayaku | by OSAKA | | by Shin-Etsu | |
| | Co., Ltd. | ORGANIC | | Chemical Co., | |
| | (dipentaerythritol | CHEMICAL | | Ltd. | |
| | hexaacrylate) | INDUSTRY Ltd. | | (Mw = 15000) | |
| Example 2 | as above | as above | 50 | as above | 20 |
| Example 3 | as above | as above | 50 | as above | 40 |
| Example 4 | as above | as above | 50 | as above | 60 |
| Example 5 | as above | as above | 20 | as above | 20 |
| Example 6 | as above | as above | 100 | as above | 20 |
| Example 7 | as above | as above | 50 | X-22-4952 | 20 |
| | | | | manufactured | |
| | | | | by Shin-Etsu | |
| | | | | Chemical Co., | |
| | | | | Ltd. | |
| | | | | (Mw = 6000) | |
| Example 8 | PETIA | as above | 20 | X-22-6266 | 20 |
| | manufactured by | | | manufactured | |
| | Daicel-Cytec | | | by Shin-Etsu | 20 |
| | Company Ltd. | | | Chemical Co., | |
| | (pentaerythritol | | | Ltd. | |
| | acrylate) | | | (Mw = 15000) | |
| Example 9 | as above | as above | 50 | as above | 20 |
| Example | as above | as above | 100 | as above | 20 |
| 10 | | | | | |

*1parts by mass based on 100 parts by mass of acrylc monomer
*2parts by mass based on 100 parts by mass in total of acrylic monomer and dendrimer acrylate

TABLE 2

| | Binder resin | | | | |
|---|---|---|---|---|---|
| | Acrylic monomer | Dendrimer acrylate | | Modified silicone compound | |
| | Type | Type | Content*1 | Type | Content*2 |
| Comparative | KAYARAD DPHA | SIRIUS-501 | 50 | KF-353 | 20 |
| Example 1 | manufactured by | manufactured by | | manufactured by | |
| | Nippon Kayaku Co., | OSAKA ORGANIC | | Shin-Etsu | |
| | Ltd. | CHEMICAL | | Chemical Co., Ltd. | |
| | (dipentaerythritol | INDUSTRY Ltd. | | (polyether- | |
| | hexaacrylate) | | | modified silicone, | |
| | | | | Mw = 15000) | |
| Comparative | as above | as above | 50 | KF-9701 | 20 |
| Example 2 | | | | manufactured by | |
| | | | | Shin-Etsu | |
| | | | | Chemical Co., Ltd. | |
| | | | | (hydroxyl group- | |
| | | | | modified silicone, | |
| | | | | Mw = 4000) | |
| Comparative | as above | as above | 50 | X-22-1602 | 20 |
| Example 3 | | | | manufactured by | |
| | | | | Shin-Etsu | |
| | | | | Chemical Co., Ltd. | |
| | | | | (polyether-acrylic | |
| | | | | co-modified | |
| | | | | silicone, Mw = | |
| | | | | 12000) | |
| Comparative | as above | as above | 50 | KF-96-300CS | 20 |
| Example 4 | | | | manufactured by | |
| | | | | Shin-Etsu | |
| | | | | Chemical Co., Ltd. | |
| | | | | (dimethyl silicone, | |
| | | | | Mw = 12000) | |
| Reference | PETIA manufactured | — | — | X-22-6266 | 20 |
| Example 1 | by Daicel-Cytec | | | manufactured by | |
| | Company Ltd. | | | Shin-Etsu | |
| | (pentaerythritol | | | Chemical Co., Ltd. | |
| | acrylate) | | | (Mw = 15000) | |
| Reference | KAYARAD DPHA | — | — | as above | 20 |
| Example 2 | manufactured by | | | | |
| | Nippon Kayaku Co., | | | | |
| | Ltd. | | | | |
| | (dipentaerythritol | | | | |
| | hexaacrylate) | | | | |

*1parts by mass based on 100 parts by mass of acrylic monomer
*2parts by mass based on 100 parts by mass in total of acrylic monomer and dendrimer acrylate

TABLE 3

| | Electro- | Surface | Contact angle | Contact angle | | Percent change | | | Image quality | |
|---|---|---|---|---|---|---|---|---|---|---|
| | photographic | hardness | before durability | after durability | Change in | in contact angle | Discharge | | | After 5000 |
| | member | (GPa) | test (°) | test (°) | angle (°) | (%) | durability | Bleeding | Initial | sheets |
| Example 1 | Intermediate | 0.44 | 33.1 | 29.9 | 3.2 | 9.7 | A | A | A | B |
| | transfer belt 1 | | | | | | | | | |
| Example 2 | Intermediate | 0.36 | 33.1 | 32.2 | 0.9 | 2.7 | A | A | A | A |
| | transfer belt 2 | | | | | | | | | |
| Example 3 | Intermediate | 0.34 | 33.4 | 32.9 | 0.5 | 1.5 | A | A | A | A |
| | transfer belt 3 | | | | | | | | | |
| Example 4 | Intermediate | 0.33 | 33.6 | 33.5 | 0.1 | 0.3 | A | A | A | A |
| | transfer belt 4 | | | | | | | | | |
| Example 5 | Intermediate | 0.34 | 31.5 | 30.4 | 1.1 | 3.5 | A | A | A | A |
| | transfer belt 5 | | | | | | | | | |
| Example 6 | Intermediate | 0.48 | 31.3 | 28.5 | 2.8 | 8.9 | A | A | A | A |
| | transfer belt 6 | | | | | | | | | |
| Example 7 | Intermediate | 0.32 | 32.5 | 32.1 | 0.4 | 1.2 | A | A | A | A |
| | transfer belt 7 | | | | | | | | | |
| Example 8 | Intermediate | 0.3 | 34.1 | 33.3 | 0.8 | 2.3 | A | A | A | A |
| | transfer belt 8 | | | | | | | | | |
| Example 9 | Intermediate | 0.33 | 34.4 | 32.8 | 1.6 | 4.7 | A | A | A | A |
| | transfer belt 9 | | | | | | | | | |
| Example 10 | Intermediate | 0.41 | 32.5 | 29.7 | 2.8 | 8.6 | A | A | A | A |
| | transfer belt 10 | | | | | | | | | |
| Comparative | Intermediate | 0.28 | 31.5 | 25.4 | 6.1 | 19.4 | C | C | A | D |
| Example 1 | transfer belt 11 | | | | | | | | | |
| Comparative | Intermediate | F | — | — | — | — | — | — | — | — |
| Example 2 | transfer belt 12 | | | | | | | | | |
| Comparative | Intermediate | 0.42 | 33.1 | 12.5 | 20.6 | 62.2 | C | A | A | D |
| Example 3 | transfer belt 13 | | | | | | | | | |
| Comparative | Intermediate | F | — | — | — | — | — | — | — | — |
| Example 4 | transfer belt 14 | | | | | | | | | |
| Reference | Intermediate | 0.22 | 33.2 | 31.4 | 1.8 | 5.4 | A | A | A | C |
| Example 1 | transfer belt 15 | | | | | | | | | |
| Reference | Intermediate | 0.25 | 33.1 | 30.9 | 2.2 | 6.6 | A | A | A | C |
| Example 2 | transfer belt 16 | | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-250402, filed on 10 Dec. 2014, and No. 2015-107875, filed on 27 May 2015, which are hereby incorporated by reference herein in their entirety.

What is claimed is:

1. An electrophotographic member comprising a substrate and a surface layer,
wherein
the surface layer comprises
a binder resin having an acrylic skeleton, and
a modified silicone compound having a polyether group and a hydroxyl group in a molecule,
a surface of the surface layer constitutes a surface of the electrophotographic member,
the surface of the electrophotographic member has a surface hardness measured by a nano-indentation method of 0.30 GPa or more and 0.50 GPa or less, and
the surface of the electrophotographic member has contact angles with n-hexadecane of γ1 and γ2, wherein
γ2 is a contact angle of the surface of the electrophotographic member that has been subjected to an accelerated discharge test and left for 24 hours after the accelerated discharge test,
γ1 is a contact angle of the surface of the electrophotographic member that is not subjected to the accelerated discharge test,
γ1 is 30.0° or more and 40.0° or less, and
a percent change in the contact angle defined by the following calculation formula (1) is 10% or less
percent change(%)=(|γ1−γ2|/γ1)×100. Calculation formula (1)

2. The electrophotographic member according to claim 1, wherein the binder resin has a dendrimer structure.

3. The electrophotographic member according to claim 1, wherein the modified silicone compound has a weight-average molecular weight (Mw) of 5000 or more and 20000 or less.

4. The electrophotographic member according to claim 1, wherein the modified silicone compound has a structure represented by formula (1) below: 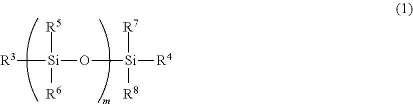
where m represents an integer of 2 or more and 300 or less, R³ to R⁸ each represent a hydrocarbon group having 1 to 3 carbon atoms or a structure represented by chemical formula (2) below, and at least one of R³ to R⁸ represents a structure represented by the formula (2) below, 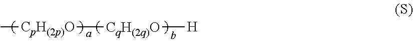
where p and q each independently represent an integer of 2 or more, and a and b each independently represent an integer of 1 or more.

5. The electrophotographic member according to claim 1, wherein the modified silicone compound has a structure represented by formula (3) below: 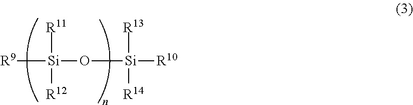
where n represents an integer of 2 or more and 300 or less, R⁹ to R¹⁴ each represent a hydrocarbon group having 1 to 3 carbon atoms or a structure represented by chemical formula (4) below, and at least one of R⁹ to R¹⁴ represents a structure represented by the formula (4) below, 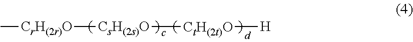
where r, s, and t each independently represent an integer of 2 or more and c and d represent an integer of 1 or more.

6. The electrophotographic member according to claim 5, wherein the modified silicone compound has a structure represented by formula (5) below: 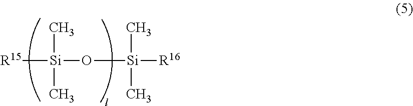
where R¹⁵ and R¹⁶ each independently represent a structure represented by formula (6) below and l represents an integer of 2 or more and 300 or less, 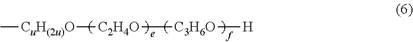
where u represents an integer of 2 or more and 6 or less and e and f each independently represent an integer of 1 or more and 50 or less.

7. The electrophotographic member according to claim 1, wherein a content of the modified silicone compound in the surface layer is 5 mass % or more and 60 mass % or less based on a resin component in the surface layer.

8. The electrophotographic member according to claim 1, wherein the binder resin is a cured product of a trifunctional to octafunctional acrylic monomer and a dendrimer acrylate.

9. The electrophotographic member according to claim 1, having an endless belt shape.

10. An electrophotographic image forming apparatus comprising an electrophotographic member, wherein
the electrophotographic member comprises
a substrate, and
a surface layer,
the surface layer comprises
a binder resin having an acrylic skeleton, and
a modified silicone compound having a polyether group and a hydroxyl group in a molecule,
a surface of the surface layer constitutes a surface of the electrophotographic member,
the surface of the electrophotographic member has a surface hardness measured by a nano-indentation method of 0.30 GPa or more and 0.50 GPa or less, and
the surface of the electrophotographic member has contact angles with n-hexadecane of γ1 and γ2, wherein
γ2 is a contact angle of the surface of the electrophotographic member that has been subjected to an accelerated discharge test and left for 24 hours after the accelerated discharge test,
γ1 is a contact angle of the surface of the electrophotographic member that is not subjected to the accelerated discharge test,
γ1 is 30.0° or more and 40.0° or less, and
a percent change in the contact angle defined by the following calculation formula (1) is 10% or less
percent change(%)=(|γ1−γ2|/γ1)×100. Calculation formula (1)

11. The electrophotographic image forming apparatus according to claim 10, comprising:
an electrophotographic photosensitive member;
an intermediate transfer body onto which an unfixed toner image formed on the electrophotographic photosensitive member is primarily transferred; and
a secondary transfer device configured to secondarily transfer the toner image transferred onto the intermediate transfer body onto a recording medium,
wherein the intermediate transfer body is the electrophotographic member.
